(19) United States
(12) Patent Application Publication
(10) Pub. No.: US 2026/0253582 A1
(43) Pub. Date: Aug. 27, 2026

(54) METHOD AND DEVICE WITH SPEECH RECOGNITION

(71) Applicants: SAMSUNG ELECTRONICS CO., LTD., Suwon-si (KR); Seoul National University R&DB Foundation, Seoul (KR)

(72) Inventors: Nam Soo KIM, Seoul (KR); Ju Yeon KANG, Seoul (KR)

(73) Assignees: SAMSUNG ELECTRONICS CO., LTD., Suwon-si (KR); Seoul National University R&DB Foundation, Seoul (KR)

(21) Appl. No.: 19/324,498

(22) Filed: Sep. 10, 2025

(30) Foreign Application Priority Data
Feb. 24, 2025 (KR) 10-2025-0023900

(51) Int. Cl. G10L 15/16; G06N 3/0455; G06N 3/048; G06N 3/0895

(52) U.S. Cl. CPC G10L 15/16; G06N 3/0455; G06N 3/048; G06N 3/0895

(57) ABSTRACT

A processor-implemented method includes generating evidence for respective frames of speech data by inputting the speech data to an encoder of a speech recognition model, determining, based on the evidence, class probabilities for the respective frames, and estimating, based on the evidence, an uncertainty of the speech recognition model for the respective frames.

### CROSS-REFERENCE TO RELATED APPLICATIONS

This application claims the benefit under 35 USC § 119(a) of Korean Patent Application No. 10-2025-0023900 filed on Feb. 24, 2025 in the Korean Intellectual Property Office, the entire disclosure of which is incorporated herein by reference for all purposes.

### BACKGROUND

### 1. Field

The following description relates to a method and device with speech recognition.

### 2. Description of Related Art

Speech recognition technology is technology that receives speech data as an input and converts the speech data into text data and may be utilized in various application fields. For example, speech recognition technology may be used in voice assistant systems, automatic translation systems, medical consultation systems, financial services, and the like.

A speech recognition model may operate based on a probabilistic approach. For example, a speech recognition model may divide speech data into multiple frames and estimate, for each of the frames, the probability of belonging to a specific class. For this purpose, a neural network-based speech recognition model may be used, which may learn patterns of input data and convert specific speech patterns into character units or word units.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes generating evidence for respective frames of speech data by inputting the speech data to an encoder of a speech recognition model, determining, based on the evidence, class probabilities for the respective frames, and estimating, based on the evidence, an uncertainty of the speech recognition model for the respective frames.

The method may include determining Dirichlet distribution parameters based on the evidence.

The determining of the class probabilities may include determining class probabilities for respective classes by dividing Dirichlet distribution parameter values for the respective classes by a sum of all parameters.

The estimating of the uncertainty of the speech recognition model may include estimating, based on the Dirichlet distribution parameters, the uncertainty of the speech recognition model for the respective frames.

The generating of the evidence may include generating the evidence by receiving an output of the encoder as an input and applying an activation function to the input.

The method may include outputting a speech recognition result by decoding the class probabilities.

The method may include redetermining, based on the estimated uncertainty of the speech recognition model for the respective frames, the class probabilities for the respective frames, and generating a speech recognition result by decoding the redetermined class probabilities.

The speech recognition model may include a connectionist temporal classification (CTC)-based speech recognition model.

In one or more general aspects, a non-transitory computer-readable storage medium may store instructions that, when executed by one or more processors, configure the one or more processors to perform any one, any combination, or all of operations and/or methods described herein.

In one or more general aspects, a processor-implemented method includes generating evidence for respective frames of speech data by inputting the speech data to an encoder of a speech recognition model, determining Dirichlet distribution parameters based on the evidence, determining, based on the Dirichlet distribution parameters, class probabilities for the respective frames, generating a target label for the respective frames of the speech data, using a pre-trained model, determining a first loss function, based on a ground truth (GT) transcription corresponding to the speech data and the class probabilities, determining a second loss function, based on the Dirichlet distribution parameters and the target label, and training the speech recognition model based on the first loss function and the second loss function.

The determining of the second loss function may include applying a normalization function to minimize a difference between the target label and the Dirichlet distribution parameters.

The generating of the evidence may include generating the evidence by receiving an output of the encoder as an input and applying an activation function to the input.

The method may include generating other evidence for other respective frames of other speech data by inputting the other speech data to the encoder of the trained speech recognition model, determining, based on the other evidence, other class probabilities for the other respective frames, and outputting a speech recognition result by decoding the other class probabilities.

In one or more general aspects, an electronic device includes one or more processors comprising processing circuitry, and memory comprising one or more storage media storing instructions that, when executed individually or collectively by the one or more processors, cause the electronic device to generate evidence for respective frames of speech data by inputting the speech data to an encoder of a speech recognition model, determine, based on the evidence, class probabilities for the respective frames, and estimate, based on the evidence, an uncertainty of the speech recognition model for the respective frames.

The execution of instructions may cause the electronic device to determine Dirichlet distribution parameters based on the evidence.

For the determining of the class probabilities, the execution of instructions may cause the electronic device to determine class probabilities for respective classes by dividing Dirichlet distribution parameter values for the respective classes by a sum of all parameters.

For the estimating of the uncertainty of the speech recognition model, the execution of instructions may cause the electronic device to estimate, based on the Dirichlet distribution parameters, the uncertainty of the speech recognition model for the respective frames.

For the generating of the evidence, the execution of instructions may cause the electronic device to generate the evidence by receiving an output of the encoder as an input and applying an activation function to the input.

The execution of instructions may cause the electronic device to output a speech recognition result by decoding the class probabilities.

The speech recognition model may include a connectionist temporal classification (CTC)-based speech recognition model.

Other features and aspects will be apparent from the following detailed description, the drawings, and the claims.

### BRIEF DESCRIPTION OF THE DRAWINGS

FIG. 1A illustrates an example of a typical speech recognition system.

FIG. 1B illustrates an example of a speech recognition system according to one or more embodiments.

FIG. 2A illustrates an example of a deep learning operation method using an artificial neural network (ANN) according to one or more embodiments.

FIG. 2B illustrates an example of a speech recognition system according to one or more embodiments.

FIG. 3 illustrates an example of a training process of a speech recognition system according to one or more embodiments.

FIG. 4 illustrates an example of speech data, a ground truth (GT) transcription, and a target label according to one or more embodiments.

FIG. 5 illustrates an example of an operating method of a speech recognition model performing uncertainty estimation according to one or more embodiments.

FIG. 6 illustrates a flowchart of an example of a speech recognition method according to one or more embodiments.

FIG. 7 is a flowchart of an example of a training method of a speech recognition model according to one or more embodiments.

FIG. 8 illustrates an example of an uncertainty characteristic of a speech recognition model according to one or more embodiments.

FIG. 9 illustrates an example of a result of comparing Softmax-based probabilities with Dirichlet distribution-based probabilities when a speech recognition model performs prediction on data not included in training data according to one or more embodiments.

FIG. 10 illustrates an example of an electronic device according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the present disclosure. Terms, such as those defined in commonly used dictionaries, are to be interpreted as having a meaning that is consistent with their meaning in the context of the relevant art and specifically in the context of the present disclosure, and are not to be construed as an ideal or excessively formal meaning unless expressly so defined herein.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as “in an or one embodiment” and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

The examples may be implemented as various types of products such as, for example, a personal computer (PC), a laptop computer, a tablet computer, a smart phone, a television, a smart home appliance, an intelligent vehicle, a kiosk, and a wearable device. Hereinafter, examples are described in detail with reference to the accompanying drawings. In the drawings, like reference numerals are used for like elements.

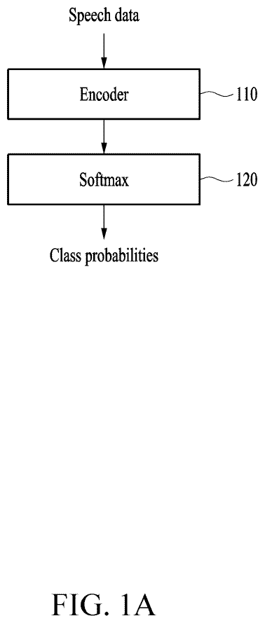

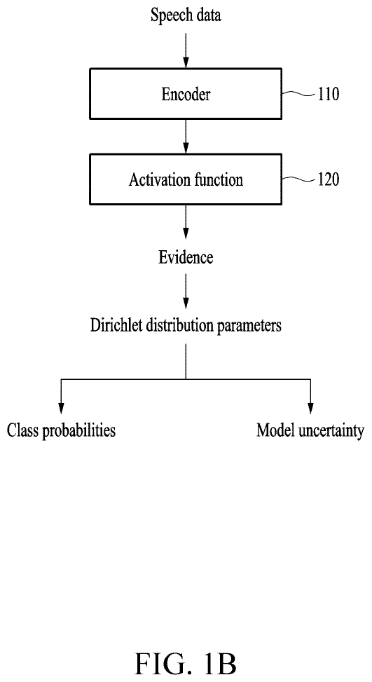

FIG. 1A illustrates an example of a typical speech recognition system.

Referring to FIG. 1A, speech data may be converted into a feature through an encoder 110, and the converted feature may be used to determine class probabilities using an activation function 120 (e.g., Softmax function). The Softmax function is a function that may convert an input feature into a probability value and may output a probability for a specific class by normalizing the probability together with a probability for another class. The Softmax function may work by converting an input score (logit) of each class, using an exponential function, and subsequently normalizing the probabilities of all classes in order to determine the probability for a specific class.

The Softmax function may be useful for predicting the probability of a specific class, but the probability value itself may not directly reflect an uncertainty of a model. The Softmax function may excessively amplify a small difference between input values during a process of normalizing the probabilities, which may cause the model to predict a high probability for a specific class, even for data with low confidence. In addition, the model may have overconfidence about data that is not included in training data (e.g., out-of-distribution data), and accordingly, the uncertainty of the model may not be properly assessed.

FIG. 1B illustrates an example of a speech recognition system according to one or more embodiments.

Referring to FIG. 1B, speech data may be converted into a feature through the encoder 110, and the converted feature may be converted into evidence through the activation function 120. Based on the evidence, Dirichlet distribution parameters may be determined, and class probabilities and an uncertainty of a model may be determined using the Dirichlet distribution parameters. Evidence may be a value that reflects a probability that input speech data belongs to a specific class and, unlike the typical Softmax-based probability value, may be used as an input for directly modeling a probability distribution. The evidence may be utilized for estimating confidence of the model about a specific class and may be a criterion for evaluating a certainty for a specific class. The encoder 110 may receive speech data and extract features through a neural network. For example, a convolutional neural network (CNN), a recurrent neural network (RNN), and/or a transformer model may be used as, or implemented by, the encoder 110.

The activation function 120 may be used to convert an output of the encoder 110 to generate evidence, and a non-linear transformation function such as Softplus or rectified linear unit (ReLU) may be used as, or included in, the activation function 120. The activation function 120 may ensure that an output value may not be a value less than or equal to 0 and may thus reflect an intensity of speech data for a specific class.

Based on the evidence, the Dirichlet distribution parameters may be determined, and probability values for a specific class may be expressed in a form of a probability distribution. The Dirichlet distribution may be characterized by a more concentrated probability distribution for a specific class as evidence for that class increases, and on the contrary, the uncertainty of the model may increase as the evidence for that class decreases.

Unlike typical Softmax-based approaches, Dirichlet distribution-based probability values may be tuned such that the model may not have a high confidence about data that is not included in training data. In addition, the uncertainty of the model may be determined using the Dirichlet distribution parameters and may serve as a criterion for quantitatively evaluating confidence of the model regarding specific data. When the uncertainty of the model is high, it may indicate that the model has less confidence about the data, and on the contrary, when the uncertainty of the model is low, it may indicate that the model has more confidence about the data.

Typical evidential deep learning may be used as a method of evaluating whether the model performs reliable prediction for the data not included in the training data (e.g., out-of-distribution data). However, typical evidential deep learning may mainly be utilized in classification tasks for images or individual data points, and there may be limitations in directly applying the typical evidential deep learning to a speech recognition system that determines an output in a form of a continuous sequence. In general image classification tasks, each piece of input data may be mapped to an independent class. However, speech recognition may be characterized by temporally continuous input data and a prediction in a specific frame may affect a prediction in a subsequent frame. In addition, in a speech recognition model, there are many cases in which there is no target label for each specific frame, so it may be difficult to directly apply a method of estimating uncertainty used in existing image classification tasks. In contrast, as described in detail below, the speech recognition system of one or more embodiments may, considering the above, include a structure that models the Dirichlet distribution based on evidence in units of frames and estimates class probabilities and model uncertainty, thereby accurately determining continuous outputs and/or an output in a form of a continuous sequence.

The speech recognition system may be applied to various technical fields, as non-limiting examples. A voice assistant system may recognize and execute voice commands of a user and may be used in smartphones, smart speakers, and in-vehicle systems. An automatic translation system may convert input speech into other languages and may be applied to real-time interpretation services also. Speech recognition may be used in a medical consultation system to analyze a patient's symptoms and help medical staff obtain accurate information, and in financial services to recognize a customer's voice to perform security authentication or process financial transaction requests.

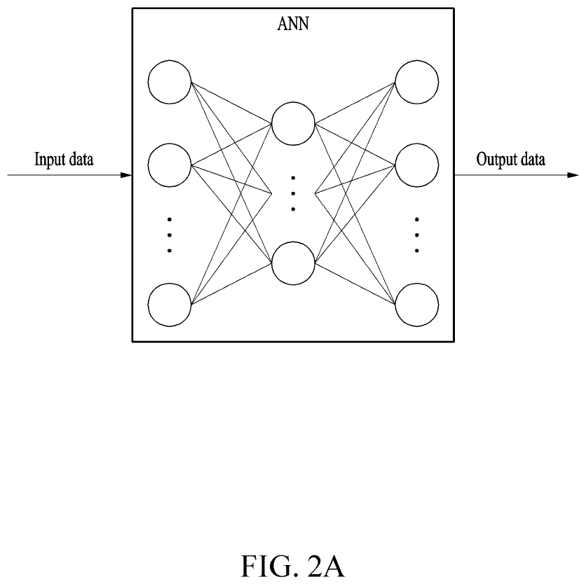

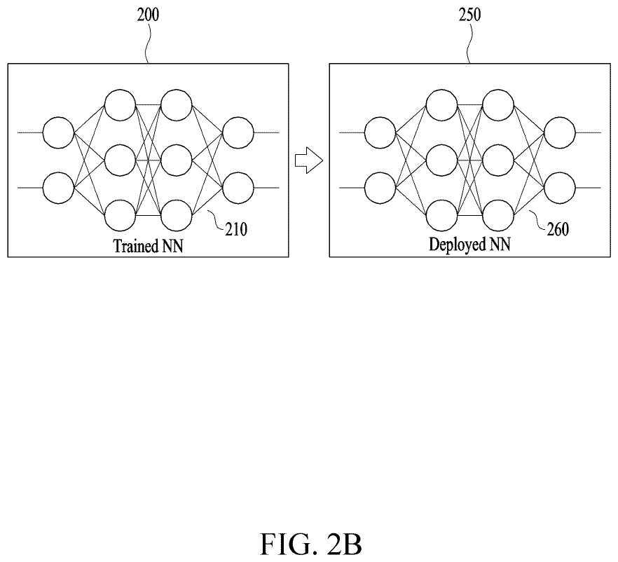

The speech recognition system of one or more embodiments may quantitatively estimate the uncertainty of the model, unlike a typical Softmax-based probability calculation method. In typical methods, a model tends to have high confidence even about untrained data. However, according to an example, the confidence of the model may be evaluated by utilizing a Dirichlet distribution-based approach. In addition, since the uncertainty may be estimated on a frame-by-frame basis, it the speech recognition system of one or more embodiments may assess whether a prediction by the model in a particular section is reliable. Using the reliability assessment, the speech recognition system of one or more embodiments may increase confidence of speech recognition results and provide more stable performance in real application environments. Before explaining an operation of the speech recognition system, an example of a deep learning operation method using an artificial neural network (ANN) is first explained with reference to FIGS. 2A and 2B.

FIG. 2A illustrates an example of a deep learning operation method using an ANN according to one or more embodiments.

An artificial intelligence (AI) algorithm including deep learning may input input data to an ANN, train the ANN with output data through operations such as convolution, and extract features using the trained ANN. The ANN may be a computational architecture that models a biological brain. In the ANN, nodes, which correspond to neurons in the brain, are connected to each other and collectively operate to process the input data. Various types of neural networks include, for example, a CNN, an RNN, a deep belief network (DBN), and a restricted Boltzmann machine (RBM) model. However, examples are not limited thereto. In a feed-forward neural network, nodes of the neural network have links to other nodes. The links may expand in one direction, for example, a forward direction, through the neural network.

FIG. 2A illustrates a structure of an ANN (e.g., a CNN) that receives input data and outputs output data. The ANN may be a deep neural network including at least two layers.

FIG. 2B illustrates an example of a speech recognition system according to one or more embodiments.

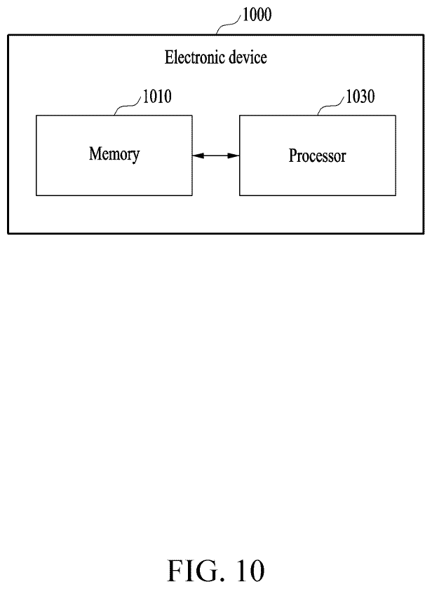

Referring to FIG. 2B, the speech recognition system may include a training device 200 (e.g., an electronic device 1000 of FIG. 10) and an inference device 250 (e.g., the electronic device 1000 of FIG. 10). The training device 200 may correspond to a computing device having various processing functions such as generating a neural network, training (or learning) a neural network, and/or retraining a neural network. For example, the training device 200 may be implemented as various types of devices such as a PC, a server device, a mobile device, and the like.

The training device 200 may generate one or more trained neural networks 210 by repetitively training (or learning) a given initial neural network. The generating of the one or more trained neural networks 210 may include determining neural network parameters. The neural network parameters may include various types of data, for example, input/output activations, weights, and biases of a neural network that are input to and output from the neural network. When the neural network is repeatedly trained, the parameters of the neural network may be tuned to determine a more accurate output for a given input.

The training device 200 may transmit the one or more trained neural networks 210 to the inference device 250. The inference device 250 may be, for example, a mobile device or an embedded device. The inference device 250 may be dedicated hardware for driving a neural network and may be an electronic device including at least one of a processor, memory, an input/output (I/O) interface, a display, a communication interface, and/or a sensor. For example, the sensor may include speech recognition sensors (e.g., a microphone) for receiving input speech data.

The inference device 250 may be any digital device that includes a memory element and a microprocessor and has an operational capability, such as a tablet PC, a smartphone, a PC (e.g., a notebook computer), an AI speaker, a smart TV, a mobile phone, a navigation, a web pad, a personal digital assistant (PDA), a workstation, and the like.

The inference device 250 may drive the one or more trained neural networks 210 without a change thereto or may drive a neural network 260 obtained by processing (for example, quantizing) the one or more trained neural networks 210. The inference device 250 for driving the neural network 260 may be implemented in a separate device, independent of the training device 200. However, examples are not limited thereto. The inference device 250 may also be implemented in the same device as the training device 200. In a non-limiting example, the inference device 250 may be or include the training device 200, and the neural network 260 may be or include the one or more trained neural networks 210.

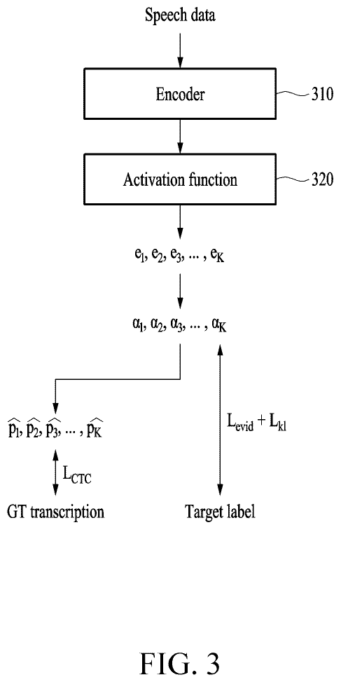

FIG. 3 illustrates an example of a training process of a speech recognition system according to one or more embodiments. The description provided with reference to FIGS. 1B to 2B may substantially identically apply to FIG. 3.

Referring to FIG. 3, a training method according to an example is described as being performed by the training device 250 described with reference to FIG. 2B. However, the training method may be used by any other suitable electronic device and in any suitable system. The training device 200 may obtain speech data (e.g., speech data for training) and extract features through an encoder 310. An output of the encoder 310 may be converted through an activation function 320, and a value obtained by conversion may be used as evidence. For example, the activation function 320 may be a Softplus function. The evidence may be a value that indicates confidence about a specific class and may be expressed as e₁, e₂, e₃, . . . , and e_{K}.

Based on the evidence, parameters of the Dirichlet distribution may be determined, and the Dirichlet distribution parameters for each class may be expressed as a₁, a₂, a₃, . . . , and a_{K}. The Dirichlet distribution may be used to quantify an uncertainty of a model and may be utilized for evaluating confidence about predictions as well as class probabilities. The Dirichlet distribution may be defined as in Equation 1 below, for example.

$$D ( p \vert α ) = \frac{1}{B ( α )} {\prod }_{i = 1}^{K} {P}_{i}^{{α}_{i} - 1} \qquad Equation 1$$

In Equation 1, B (a) denotes a normalization constant and p=[p₁, p₂, . . . , p_{K}] denotes class probabilities. In addition, the Dirichlet distribution parameters [α₁, α₂, . . . , α_{K}] may be a factor that controls the confidence about a specific class. The class probabilities may be produced using the Dirichlet distribution parameters, and the class probabilities may be determined as in Equation 2 below, for example.

$${\hat{p}}_{k} = \frac{{α}_{k}}{{\sum }_{i = 1}^{K} {α}_{i}} \qquad Equation 2$$

The training method may determine the class probabilities by using a mean of the Dirichlet distribution without undergoing Softmax. A speech recognition model may analyze input speech data and convert content of the speech into text data. The speech recognition model may have various structures and may operate in determined ways. The speech recognition model may include a connectionist temporal classification (CTC)-based speech recognition model. A CTC-based speech recognition model according to an example may be designed to learn unaligned continuous speech data. In general, the speech recognition model may predict a ground truth (GT) transcription using class probabilities in units of frames. The CTC-based speech recognition model may learn to find an optimal probability path even in data with no alignment between the input speech data and the GT transcription.

In the speech recognition model, an objective function may be determined based on the class probabilities, and a CTC objective function L_{CTC} may be defined for a CTC-based speech recognition model. The CTC objective function L_{CTC} may be used to minimize a difference between the GT transcription and the class probabilities. In the CTC-based speech recognition model, training may be performed by maximizing the probability of generating the GT transcription using the class probabilities in units of frames. Thus, the CTC objective function L_{CTC} may be optimized using the Dirichlet distribution-based class probabilities. The CTC-based speech recognition objective function may be defined as in Equation 3 below, for example.

$${L}_{CTC} = - {Σ}_{( x , {y}^{*} )} log p ( {y}^{*} \vert x ) \qquad Equation 3$$

In Equation 3, p(y*|x) denotes a probability of the GT transcription y* being generated when the input speech x is given. In addition, the training device 200 may perform additional training using a target label together with the GT transcription.

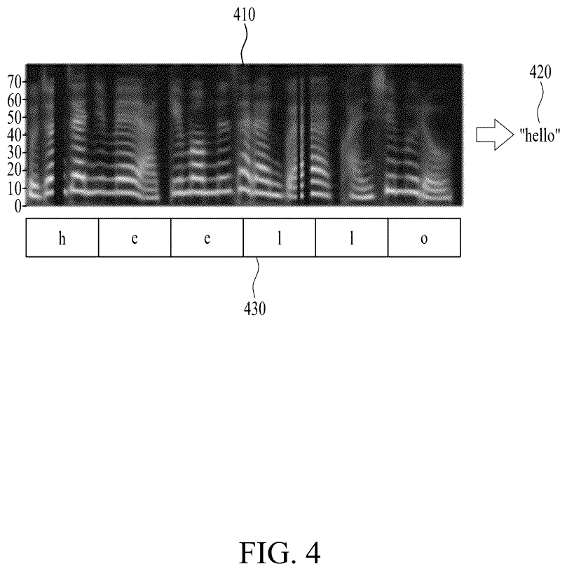

To train the Dirichlet distribution for each frame, the target label y may be needed for each frame. However, due to the characteristics of the speech recognition model, there may not be a direct target label for each frame. Thus, the training device 200 may extract a class label having a highest probability in each frame from an inference result of a pre-trained speech recognition model and use the class label in the training process. Hereinafter, a method of generating a target label is described with reference to FIG. 4.

FIG. 4 illustrates an example of speech data, a GT transcription, and a target label according to one or more embodiments. The description provided with reference to FIGS. 1B to 3 may identically apply to FIG. 4.

Referring to FIG. 4, speech data 410 may represent a speech signal that changes over time in the form of a spectrogram, and a speech recognition model may be trained based on given speech data. A GT transcription 420 is a continuous sequence of letters or words corresponding to the speech data 410 and may represent text data in a form that can be understood by humans. For example, when the speech data 410 includes the word “hello,” the corresponding GT transcription 420 may be expressed as “hello.”

A pair of the speech data 410 and the GT transcription 420 may not have a GT value in units of frames. That is, a direct alignment between each speech frame and a particular character may not be provided. Thus, to accurately train the speech recognition model, the speech recognition system of one or more embodiments may train the speech recognition model based on alignment information in units of frames between the speech data 410 and the GT transcription 420. A target label 430 may be data that may be generated such that a frame of speech data 410 may be mapped to a character of a GT transcription 420. The target label 430 may be provided such that a speech recognition model may understand a matching relationship between an input frame and output text during a training process.

The target label 430 may be generated using a pre-trained speech recognizer. The pre-trained speech recognizer may analyze the input speech data 410 to infer whether a specific frame corresponds to a specific character and may extract alignment information between the GT transcription 420 and the speech data 410. For example, referring to FIG. 4, a specific section of the speech data 410 may be mapped to characters such as “h,” “e,” “l,” “l,” and “o,” and the target label 430 may represent the alignment information.

The target label 430 may include character or blank information corresponding to each frame of the speech data 410 and may be utilized as a supervision signal in the training process of the speech recognition model. The speech recognition system of one or more embodiments may directly compare the target label 430 with an output of the speech recognition model and use a result of the comparison to determine a loss, and may apply the loss during the training process such that the speech recognition model may derive more accurate results.

Referring again to FIG. 3, as described above, a target label may be utilized in a training process for estimating the uncertainty of the model, and a second loss function for uncertainty quantification may be determined. The second loss function for uncertainty quantification may include L_{evid} and Lₖₗ and may induce the model to perform reliable predictions during the training process. L_{evid} is an evidence-based loss function that may be used to minimize a difference between the class probabilities predicted by the model and the target label 430. L_{evid} may be defined as in Equation 4 below, for example.

$${L}_{evi} = {\sum }_{j = 1}^{K} ( {( {y}_{j} - \frac{{α}_{j}}{S} )}^{2} + \frac{{α}_{j} ( S - {α}_{j} )}{{S}^{2} ( S + 1 )} ) \qquad Equation 4$$

In Equation 4, y denotes a one-hot vector of a target label, and S denotes a total sum of the Dirichlet distribution parameters, which may represent a total sum of predicted evidence values. The first term may be a factor that minimizes a difference between the target label and a predicted probability, and the second term may be a factor that adjusts the uncertainty.

In addition, a regularization term may be added to adjust evidence that is not the target label to “0,” such that more accurate uncertainty estimation may be performed. The normalized evidence may be determined as in Equation 5 below, for example.

$$\tilde{α} = y + ( 1 - y ) ⊙ α \qquad Equation 5$$

In Equation 5, ⊙ may denote element-wise multiplication.

Lₖₗ is a Kullback-Leibler divergence-based regularization loss function and may be used to adjust such that the model may estimate an appropriate uncertainty even for out-of-distribution data, which is data on which the model is not trained. Lₖₗ may be defined as in Equation 6 below, for example.

$${L}_{KL} = {v}_{λ} KL ( D ( P \vert \tilde{α} ) \vert \vert ( D ( p \vert ( 1 , 1 , ⋯ , 1 ) ) ) \qquad Equation 6$$

In Equation 6, KL(D(p|\tilde{α})∥D(p|(1, 1, . . . , 1))) may indicate the Kullback-Leibler divergence between a predicted Dirichlet distribution and a uniform Dirichlet distribution. ν_{λ} is a regularization weight (or a hyperparameter) that may control an influence of a Kullback-Leibler divergence loss.

Finally, the training device 200 may optimize a total loss function Lₜₒₜₐₗ by combining L_{CTC} with L_{evid} and Lₖₗ, which are loss functions for uncertainty quantification. The total loss function may be defined as in Equation 7 below, for example.

$${L}_{total} = {L}_{CTC} + λ ( {L}_{evid} + {L}_{KL} ) \qquad Equation 7$$

Here, λ may be a hyperparameter that adjusts weights between the loss functions. The training device 200 may receive speech data as an input, model the Dirichlet distribution based on the evidence, and learn the class probabilities and the model uncertainty. A Dirichlet distribution-based approach of one or more embodiments may provide an appropriate uncertainty even for the out-of-distribution data, the data on which the model has not been trained, and may allow the speech recognition model to generate a more reliable output.

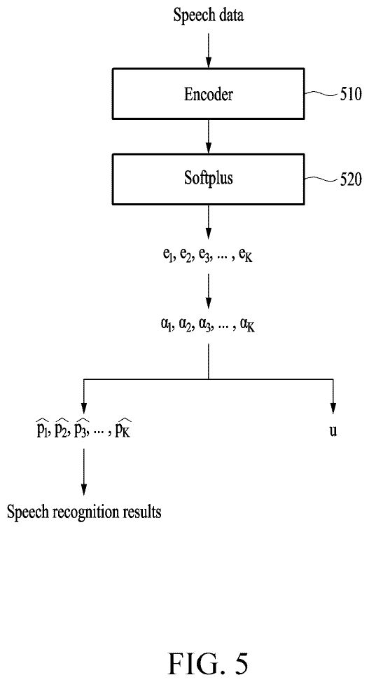

FIG. 5 illustrates an example of an operating method of a speech recognition model performing uncertainty estimation according to one or more embodiments. The description provided with reference to FIGS. 1B to 4 may identically apply to FIG. 5.

Referring to FIG. 5, speech data may be converted into a feature through an encoder 510, and the converted feature may be converted into evidence through Softplus 520. Based on the evidence, parameters of the Dirichlet distribution may be determined, and class probabilities and the uncertainty may be determined using the Dirichlet distribution parameters.

During the operation of the speech recognition model, input speech data may be converted through the encoder 510. An output of the encoder 510 may be converted into evidence by applying the Softplus 520. The Softplus 520 may be defined as in Equation 8 below, for example.

$$softplus ( x ) = log ( 1 + {e}^{x} ) \qquad Equation 8$$

The Softplus 520 may ensure that an output value may always be greater than or equal to 0, thereby preventing an evidence value from becoming negative. The evidence may be a value that indicates confidence about a specific class and may be expressed as e₁, e₂, e₃, . . . , and e_{K}.

Based on the evidence, the parameters of the Dirichlet distribution may be determined. The parameters of the Dirichlet distribution for each class may be defined as in Equation 9 below, for example.

$${α}_{k} = {e}_{k} + 1 for each class k \qquad Equation 9$$

In Equation 9, αₖ may be a parameter of the Dirichlet distribution for a specific class k and may be determined by adding 1 to the evidence eₖ. The parameters of the Dirichlet distribution may be used to determine class probabilities according to Equation 2. Each of the class probabilities may represent a probability of belonging to the corresponding class in a specific frame, and speech recognition results may be derived based on each of the class probabilities.

In addition, the uncertainty may be determined using the Dirichlet distribution parameters. The uncertainty u may be defined as in Equation 10 below, for example.

$$u = \frac{K}{{\sum }_{i = 1}^{K} {α}_{i}} \qquad Equation 10$$

In Equation 10, K denotes a total number of classes, and the uncertainty u may quantitatively represent confidence about a class probability predicted by the model. A higher uncertainty value may indicate that the model has a lower confidence in the corresponding frame, while a lower uncertainty value may indicate that the model has a higher confidence about a prediction result for the corresponding frame.

The speech recognition model may estimate the uncertainty on a frame-by-frame basis, and when an uncertainty in a particular frame is high, it may be difficult to trust a prediction result for that frame. For example, when the speech data includes the word “hello,” probabilities for “h,” “e,” “l,” “l,” and “o” in a particular frame may be respectively determined, and the uncertainty may be high in some frames. Frames with high uncertainty may be areas including patterns or noise that are not trained on, whereas frames with low uncertainty may be areas for which relatively reliable predictions are performed.

The speech recognition model may decode the class probability to generate a final transcription. After the class probabilities are derived, CTC decoding, beam search decoding, and/or language model-based post-processing methods may be applied to generate transcriptions. For example, a CTC-based speech recognition model may apply a method that organizes consecutive identical characters predicted into a single character and may include a process of removing blank symbols.

The inference device 250 may estimate a class probability and an uncertainty on a frame-by-frame basis for the input speech data and may output a speech recognition result based on the class probability and the uncertainty. Uncertainty information may be used to evaluate a reliability of a speech recognition system, and additional post-processing may correct a frame with a high uncertainty. For example, frames with high uncertainty may be ignored, and/or areas with high uncertainty may be re-evaluated.

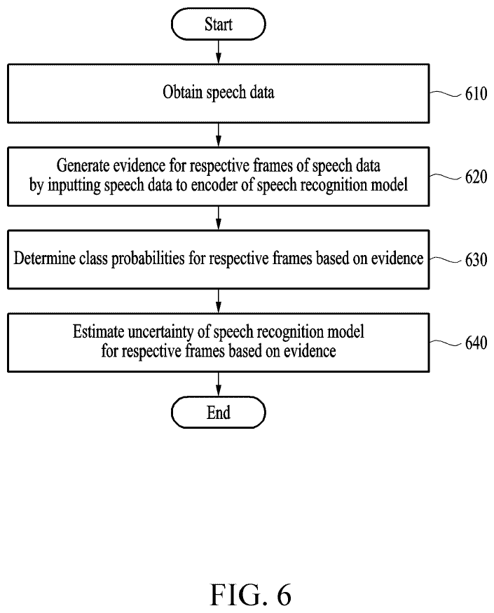

FIG. 6 illustrates a flowchart of an example of a speech recognition method according to one or more embodiments. The description provided with reference to FIGS. 1B to 5 may substantially identically apply to FIG. 6.

For ease of description, operations 610 to 640 are described as being performed using the inference device 250 shown in FIG. 1B. However, operations 610 to 640 may be performed by another suitable electronic device in any suitable system.

Furthermore, the operations of FIG. 6 may be performed in the shown order and manner. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 610, the inference device 250 may obtain speech data. For example, the speech data may be obtained (e.g., sensed and/or generated) via a microphone or other audio sensors (e.g., one or more sensors included in the inference device 250) or may be received from an external server or device via a network.

In operation 620, the inference device 250 may input speech data to an encoder of a speech recognition model to generate evidence for respective frames of the speech data. The inference device 250 may generate the evidence by receiving an output of the encoder as an input and applying an activation function to the input. The inference device 250 may generate the evidence by receiving the output of the encoder as an input and applying an activation function to the input. Here, the activation function may be a function that ensures that an output value may be greater than or equal to 0, such as Softplus. The speech recognition model may include a CTC-based speech recognition model.

The inference device 250 may determine Dirichlet distribution parameters based on the evidence.

In operation 630, the inference device 250 may determine, based on the evidence, a class probability for the respective frames. The inference device 250 may determine class probabilities for respective classes by dividing Dirichlet distribution parameter values for the respective classes by a sum of all parameters.

In operation 640, the inference device 250 may estimate, based on the evidence, an uncertainty of the speech recognition model for the respective frames. The inference device 250 may estimate the uncertainty of the speech recognition model for the respective frames based on the Dirichlet distribution parameters. Further, in operation 640, the inference device 250 may generate and output a speech recognition result by decoding the class probabilities. For example, in operation 640, the inference device 250 may generate and output, as the speech recognition result, a transcription that is a continuous sequence of letters or words corresponding to the speech data obtained in operation 610 and that represents text data in a form that can be understood by humans, based on either one or both of the decoded class probabilities and the estimated uncertainty of the speech recognition model.

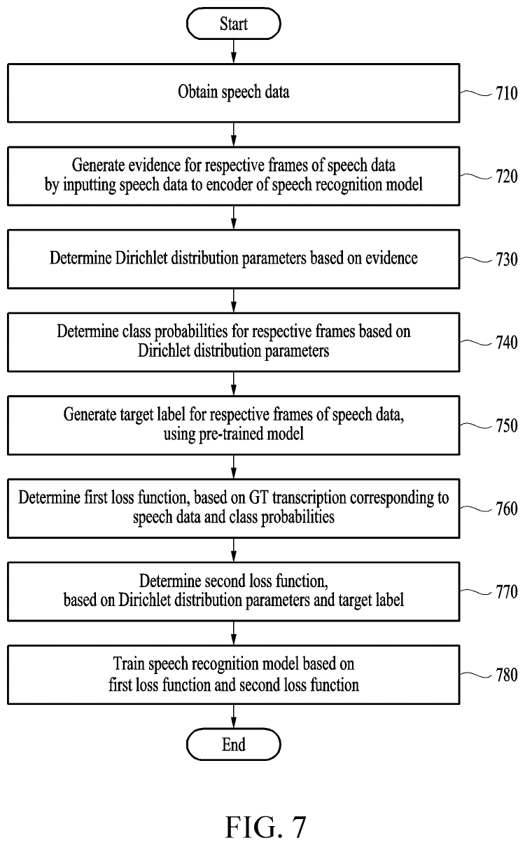

FIG. 7 is a flowchart of an example of a training method of a speech recognition model according to one or more embodiments. The description provided with reference to FIGS. 1B to 6 may substantially identically apply to FIG. 7.

For ease of description, operations 710 to 780 are described as being performed using the training device 200 shown in FIG. 1B. However, operations 710 to 780 may be performed by another suitable electronic device in any suitable system.

Furthermore, the operations of FIG. 7 may be performed in the shown order and manner. However, one or more of the operations may be performed in a different order, one or more of the operations may be omitted, two or more of the operations may be performed in parallel or simultaneously, and/or other operations may be additionally performed without departing from the spirit and scope of the described embodiments.

In operation 710, the training device 200 may obtain speech data.

In operation 720, the training device 200 may input the obtained speech data to an encoder of the speech recognition model to generate evidence for respective frames.

In operation 730, the training device 200 may determine Dirichlet distribution parameters based on the evidence.

In operation 740, the training device 200 may determine class probabilities for the respective frames based on the Dirichlet distribution parameters.

In operation 750, the training device 200 may generate a target label for the respective frames of the speech data, using a pre-trained speech recognition model. Since there may not be a direct alignment between the speech data and a transcription, the training device 200 may generate the target label for training. By using a pre-trained speech recognition model, a class having the highest probability in each frame of the speech data may be assigned as the target label.

In operation 760, the training device 200 may determine a first loss function based on a GT transcription corresponding to the speech data and the class probabilities. The first loss function may be a CTC-based loss function and may be configured to allow training without alignment between the speech data and the GT transcription.

In operation 770, the training device 200 may determine a second loss function based on the Dirichlet distribution parameters and the target label. The second loss function may allow the model to learn to match the target label based on the evidence. In addition, training may be performed by adding a regularization term to adjust evidence that is not a GT to “0,” such that uncertainty estimation may be performed more accurately.

In operation 780, the training device 200 may train the speech recognition model based on the first loss function and the second loss function.

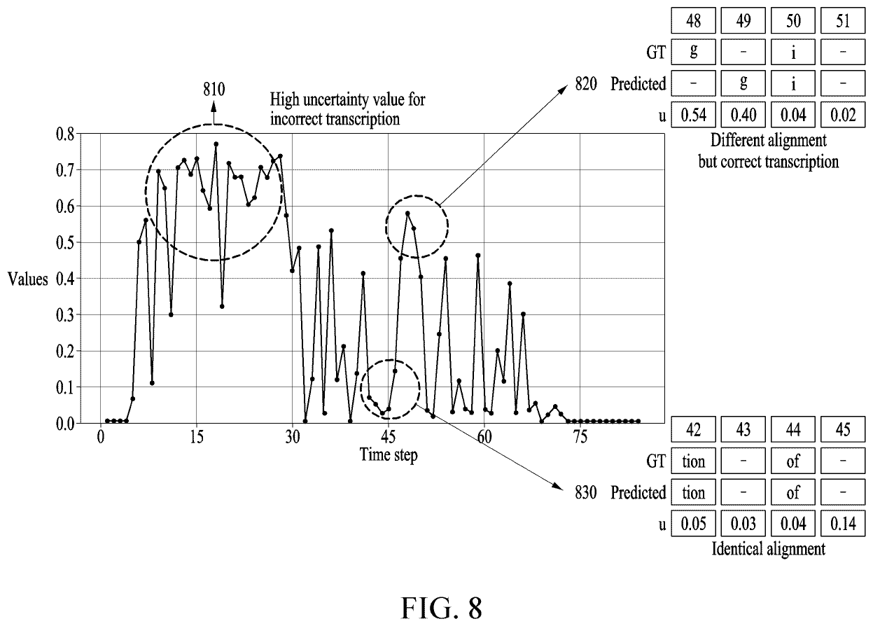

FIG. 8 illustrates an example of an uncertainty characteristic of a speech recognition model according to one or more embodiments. The description provided with reference to FIGS. 1B to 7 may substantially identically apply to FIG. 8.

Referring to FIG. 8, a transcription generated by a speech recognition model may have a characteristic of showing a high uncertainty for incorrect portions compared to a GT transcription and showing a low uncertainty for the GT transcription. A result predicted by the speech recognition model may be provided together with an uncertainty value, and FIG. 8 may explain how the uncertainty relates to accuracy of the transcription.

In the graph of FIG. 8, the x-axis may represent a time step and the y-axis may represent an uncertainty value. When the speech recognition model has a high uncertainty at a particular time step, there may be a high probability that a predicted transcription for that frame does not match the GT transcription. For example, referring to the graph of FIG. 8, it is illustrated that uncertainty values in an area 810 and an area 820 are relatively high.

Alignment examples shown along with the graph in FIG. 8 may be used to compare a predicted transcription with a GT transcription at each time step. For example, in the area 820, although the alignments are different, a meaning of the transcription is accurately predicted. The uncertainty values may be relatively high in some frames.

The speech recognition model may tune the uncertainty values by considering a difference between the predicted transcription and the GT transcription. When the uncertainty is high in a particular frame, the prediction for that frame may be unreliable. The method of one or more embodiments described with reference to FIG. 8 may be utilized to quantitatively evaluate confidence about speech recognition results and may be configured to improve performance of the model by filtering out sections with high uncertainty or applying a post-processing process.

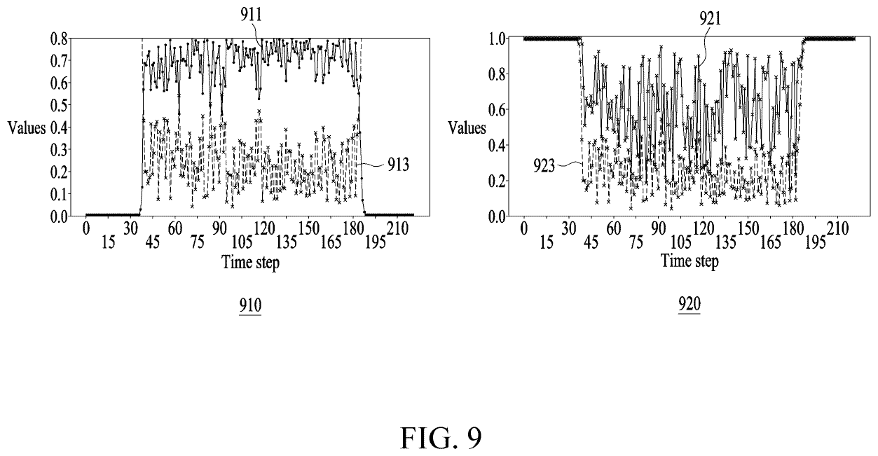

FIG. 9 illustrates an example of a result of comparing Softmax-based probabilities with Dirichlet distribution-based probabilities when a speech recognition model performs prediction on data not included in training data according to one or more embodiments. The description provided with reference to FIGS. 1B to 8 may identically apply to FIG. 9.

The speech recognition model described with reference to FIG. 9 was trained using an English dataset, LibriSpeech, and inference was performed on a Korean dataset, Zeroth-Korean, to confirm an operation on the data not included in the training data.

A first graph 910 may represent the Dirichlet distribution-based probabilities and uncertainty values. In the first graph 910, a curve 911 may represent the uncertainty values, and a curve 913 may represent the Dirichlet distribution-based probabilities (e.g., the probabilities with Dirichlet distribution). When the data not included in the training data is input, the curve 913 may generally have low probability values, and the curve 911 may indicate high uncertainty values. This result may show that the Dirichlet distribution-based approach may adjust to prevent the model from being overconfident about the probability values by assigning a high uncertainty when performing unreliable predictions on the data not included in the training data.

A second graph 920 may represent a result of comparing Softmax-based probabilities with the Dirichlet distribution-based probabilities. In the second graph 920, a curve 921 may represent the Softmax-based probabilities and a curve 923 may represent the Dirichlet distribution-based probabilities. Softmax-based probabilities generally tend to be very “peaky,” which may lead to being overconfident about incorrect predictions while assigning a high probability to a certain class. In particular, in the second graph 920, the Softmax-based probability may generate a transcription that has a value close to 1 at a specific time step and does not match the GT transcription. On the contrary, the Dirichlet distribution-based probabilities may generally maintain low values, and the probabilities may be tuned to lower confidence in an area with a high uncertainty.

Referring to the example transcription shown in the first graph 910, the GT transcription may be “In the year two thousand and fifteen, all universities in the country will be evaluated,” but the transcription generated by the speech recognition model may be output as “It tells you you mothern thega conq.” This result may show that the Dirichlet distribution-based approach may output a high uncertainty for the data not included in the training data and may assign low probability values to unreliable predictions.

In the second graph 920, a transcription of a Softmax-based speech recognition model may be compared with a transcription of a speech recognition model according to an example. When the correct transcription is “In the year two thousand and fifteen, all universities in the country will be evaluated,” the Softmax-based speech recognition model may predict “It tells you you mothern thega conq,” while the speech recognition model according to an example may predict “It turpsonial anden on go woden the ag ca cuahrt.” Although both transcriptions do not match the GT transcription, the softmax-based speech recognition model may tend to give a high probability to the incorrect transcription, whereas the speech recognition model according to an example may reflect a low probability and a high uncertainty.

In other words, the Softmax-based probabilities may tend to have high probability values even for an input different from the training data, thereby leading to overconfidence in incorrect predictions, but the Dirichlet distribution-based probabilities may output conservative probability values for the data not included in the training data by reflecting the uncertainty also.

Uncertainty estimation for the data not included in the training data may help a speech recognition system operate reliably in various environments. For example, when a language that is not supported by a real-time translation system is input, the Softmax-based model may output a result translated into a wrong language, but the Dirichlet distribution-based model, which is the speech recognition model according to an example, may adjust the model to not be overconfident about incorrect predictions, by increasing the uncertainty and assigning low probability values.

FIG. 10 illustrates an example of an electronic device according to one or more embodiments. The description provided with reference to FIGS. 1B to 9 may substantially identically apply to FIG. 10.

Referring to FIG. 10, an electronic device 1000 may include memory 1010 (e.g., one or more memories) and a processor 1030 (e.g., one or more processors). The electronic device 1000 may include the inference device 250 described with reference to FIG. 1B.

The memory 1010 may store instructions (or programs) executable by the processor 1030. For example, the instructions may include instructions for performing an operation of the processor 1030 and/or an operation of each component of the processor 1030. For example, the memory 1010 may be or include a non-transitory computer-readable storage medium storing instructions that, when executed by the processor 1030, configure the processor 1030 to perform any one, any combination, or all of the operations and/or methods disclosed herein with reference to FIGS. 1-10.

The memory 1010 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), and/or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, and/or insulator resistance change memory.

The processor 1030 may process data stored in the memory 1010. The processor 1030 may execute computer-readable code (e.g., software) stored in the memory 1010 and instructions triggered by the processor 1030.

The processor 1030 may be a hardware-implemented data processing device having a circuit that is physically structured to execute desired operations. The desired operations may include, for example, code or instructions in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 1030 may obtain speech data, generate evidence for respective frames of the speech data by inputting the speech data to an encoder of a speech recognition model, determine a class probability for the respective frames based on the evidence, and estimate an uncertainty of the speech recognition model for the respective frames based on the evidence. The processor 1030 may perform the operations described with reference to FIGS. 1B to 10 in substantially the same manner. Accordingly, a detailed description thereof is omitted.

The encoders, training devices, inference devices, electronic devices, memories, processors, encoder 110, training device 200, inference device 250, encoder 310, encoder 510, electronic device 1000, memory 1010, and processor 1030 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-10 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
generating evidence for respective frames of speech data by inputting the speech data to an encoder of a speech recognition model;
determining, based on the evidence, class probabilities for the respective frames; and
estimating, based on the evidence, an uncertainty of the speech recognition model for the respective frames.

2. The method of claim 1, further comprising determining Dirichlet distribution parameters based on the evidence.

3. The method of claim 1, wherein the determining of the class probabilities comprises determining class probabilities for respective classes by dividing Dirichlet distribution parameter values for the respective classes by a sum of all parameters.

4. The method of claim 3, wherein the estimating of the uncertainty of the speech recognition model comprises estimating, based on the Dirichlet distribution parameters, the uncertainty of the speech recognition model for the respective frames.

5. The method of claim 1, wherein the generating of the evidence comprises generating the evidence by receiving an output of the encoder as an input and applying an activation function to the input.

6. The method of claim 1, further comprising outputting a speech recognition result by decoding the class probabilities.

7. The method of claim 1, further comprising:
redetermining, based on the estimated uncertainty of the speech recognition model for the respective frames, the class probabilities for the respective frames; and
generating a speech recognition result by decoding the redetermined class probabilities.

8. The method of claim 1, wherein the speech recognition model comprises a connectionist temporal classification (CTC)-based speech recognition model.

9. A non-transitory computer-readable storage medium storing instructions that, when executed by one or more processors, configure the one or more processors to perform the method of claim 1.

10. A processor-implemented method comprising:
generating evidence for respective frames of speech data by inputting the speech data to an encoder of a speech recognition model;
determining Dirichlet distribution parameters based on the evidence;
determining, based on the Dirichlet distribution parameters, class probabilities for the respective frames;
generating a target label for the respective frames of the speech data, using a pre-trained model;
determining a first loss function, based on a ground truth (GT) transcription corresponding to the speech data and the class probabilities;
determining a second loss function, based on the Dirichlet distribution parameters and the target label; and
training the speech recognition model based on the first loss function and the second loss function.

11. The method of claim 10, wherein the determining of the second loss function comprises applying a normalization function to minimize a difference between the target label and the Dirichlet distribution parameters.

12. The method of claim 10, wherein the generating of the evidence comprises generating the evidence by receiving an output of the encoder as an input and applying an activation function to the input.

13. The method of claim 10, further comprising:
generating other evidence for other respective frames of other speech data by inputting the other speech data to the encoder of the trained speech recognition model;
determining, based on the other evidence, other class probabilities for the other respective frames; and
outputting a speech recognition result by decoding the other class probabilities.

14. An electronic device comprising:
one or more processors comprising processing circuitry; and
memory comprising one or more storage media storing instructions that, when executed individually or collectively by the one or more processors, cause the electronic device to:
generate evidence for respective frames of speech data by inputting the speech data to an encoder of a speech recognition model;
determine, based on the evidence, class probabilities for the respective frames; and
estimate, based on the evidence, an uncertainty of the speech recognition model for the respective frames.

15. The electronic device of claim 14, wherein the execution of instructions causes the electronic device to determine Dirichlet distribution parameters based on the evidence.

16. The electronic device of claim 15, wherein, for the determining of the class probabilities, the execution of instructions causes the electronic device to determine class probabilities for respective classes by dividing Dirichlet distribution parameter values for the respective classes by a sum of all parameters.

17. The electronic device of claim 15, wherein, for the estimating of the uncertainty of the speech recognition model, the execution of instructions causes the electronic device to estimate, based on the Dirichlet distribution parameters, the uncertainty of the speech recognition model for the respective frames.

18. The electronic device of claim 14, wherein, for the generating of the evidence, the execution of instructions causes the electronic device to generate the evidence by receiving an output of the encoder as an input and applying an activation function to the input.

19. The electronic device of claim 14, wherein the execution of instructions causes the electronic device to output a speech recognition result by decoding the class probabilities.

20. The electronic device of claim 14, wherein the speech recognition model comprises a connectionist temporal classification (CTC)-based speech recognition model.
